(19) United States
(12) Patent Application Publication
(10) Pub. No.: US 2002/0134025 A1
(43) Pub. Date: Sep. 26, 2002

(54) Door panel assembly

(76) Inventors: Mark Graham Lawrie, Lion on Sulias (FR); Yann Le Gallo, Orleans (FR); Pascal De Vries, Sandillion (FR); Klaus Bruno Wilhelm Blume, Nauheim (DE); Charles Berry Hopson, Lebanon, TN (US); Herve Laurandel, Clair (FR); Simon Blair Dobson, Kent (GB); Damien Cabanne, Fontainebleau (FR)

Correspondence Address: CARLSON, GASKEY & OLDS, P.C., 400 WEST MAPLE ROAD, SUITE 350, BIRMINGHAM, MI, 48009, US

(21) Appl. No.: 10/102,565

(22) Filed: Mar. 19, 2002

(30) Foreign Application Priority Data
Mar. 21, 2001 (GB) GB 0107066.3

(51) Int. Cl. B60J 5/04

(52) U.S. Cl. 49/502

(57) ABSTRACT

A door panel assembly including a door panel having a dry side and a wet side, a drive mechanism being secured to the door panel via at least a first mounting feature and a cable drum being secured to the door panel via at least a second mounting feature, in which the at least one first and at least one second mounting features are located on the same side of the door panel.

This application claims priority to United Kingdom (GB) Patent Application No. 0107066.3 filed on Mar. 21, 2001.

### BACKGROUND OF THE INVENTION

The present invention relates to door panel assemblies and particular door panel assemblies including window regulator cable drum housings for use in vehicles such as cars (automobiles).

Known cars include doors having windows. It is possible to lower and raise a window glass in order to open and close the window. The vertical position of the window glass is controlled by a window regulator, parts of which are generally secured to a lower edge of the window glass.

The door includes an outer skin and an inner door panel which provide for a cavity within the door within which is located part of the window regulator and also in which is located the window glass when in a lowered position. The door cavity side of the door inner panel is known as the “wet” side and the other side of the door inner panel i.e. the side which faces the interior of the vehicle is known as the “dry” side.

One form of window regulator is the cable operated window regulator which uses cursors attached to a cable to raise and lower the window glass. The cable is moved by wrapping ends of the cable around a cable drum and then rotating the cable drum in a clockwise or an anti-clockwise direction to raise and lower the window glass. The cable drum is secured to the wet side of the door inner panel.

A motor is secured to the dry side of a door inner panel. The motor includes an axle which projects through the panel on which the drum is rotatably mounted.

A problem with this design is the importance of aligning the cable drum housing accurately with the motor. The sandwiching of the door inner panel between these two components adds a further manufacturing tolerance error.

### SUMMARY OF THE INVENTION

An object of the present invention is to provide an improved form of door inner panel assembly.

Thus, according to the present invention that is provided, a door panel assembly including a door panel having a dry side and a wet side, a drive mechanism being secured to the door panel via at least a first mounting feature and a cable drum being secured to the door panel via at least a second mounting feature, in which the at least one first and at least one second mounting feature are located on the same side of the door panel.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a cross section view of a first embodiment of a door panel assembly according to the present invention;

FIG. 2 is a second embodiment of a door panel assembly according to the present invention.

FIG. 3 is a view of the door panel assembly of FIG. 2 taken in the direction of arrow A.

### DETAILED DESCRIPTION OF THE PREFERRED EMBODIMENT

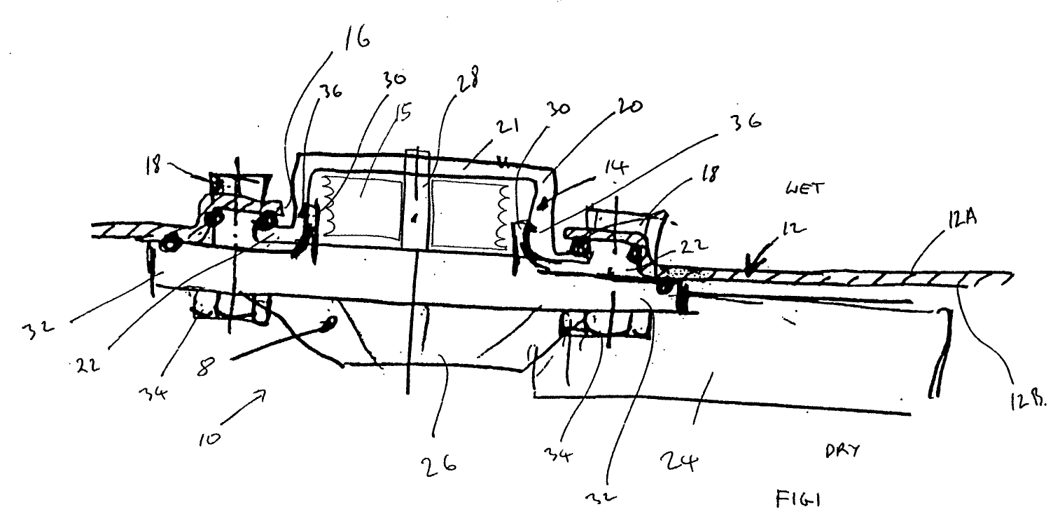

With reference to FIG. 1, there is shown a door panel assembly 10 including a door panel 12, a window regulator cable drum housing 14 and a drive mechanism in the form of a window regulator motor assembly 8.

Door panel 12 would typically be in the form of an inner panel pressing which is connected to an outer door skin to provide for a door structure of a vehicle such as a car (automobile).

Alternatively, the door panel could be in the form of a door panel module mounting plate (also known as a carrier plate) upon which is mounted various components of the door. The module mounting plate then being secured in a relatively large aperture of the inside of an associated door.

Alternatively, the door inner panel may be a window regulator motor mounting plate.

The door panel 12 includes a drum hole 16 and threaded fixing holes 18. Door panel 12 has sides 12A (wet side) and 12B (dry side).

Cable drum housing 14 includes a housing portion 20 which is generally cylindrical in shape and includes a housing portion closure 21.

Attached to the housing portion at spaced locations are mounting features in the form of lugs 22, each having a through hole.

Mounted in the housing portion 20 is a cable drum 15 around which is wound the window regulator cables.

Window regulator motor assembly 8 includes an electric motor 24 in driving connection with a gearbox housed in gearbox housing 26. The gearbox has an output axle 28, upon which is mounted the cable drum.

The gearbox housing 26 includes alignment features in the form of fingers 30 which engage with an inner surface of housing portion 20 to correctly align the window regulator motor assembly 8 with the cable drum housing 14.

Gearbox housing 26 includes mounting features in the form of lugs 32 (only two of the three lugs shown) having through holes. Bolts 34 pass through the holes in lugs 32 and lugs 22 and are threaded into threaded fixing holes 18 to secure both the window regulator motor assembly 8 and the cable drum housing 14 door panel 12.

It can be seen that the electric motor 24 and its associated electrical connectors are advantageously located on the dry side of the door panel 12. Furthermore, it can be seen that features of the window regulator motor assembly engage directly with features of the cable drum housing to provide for correct alignment between these two components. It should be noted that manufacturing tolerance errors in door panel 12 do not affect the alignment between window regulator motor assembly 8 and cable drum housing 14.

It should also be noted that the window regulator motor assembly 8 and cable drum housing 14 can be provided as a sub-assembly prior to fixing on to the door panel 12. To this end, fingers 30 are provided with barbs 36 to provide for a snap fit engagement with the inner part of housing portion 20.

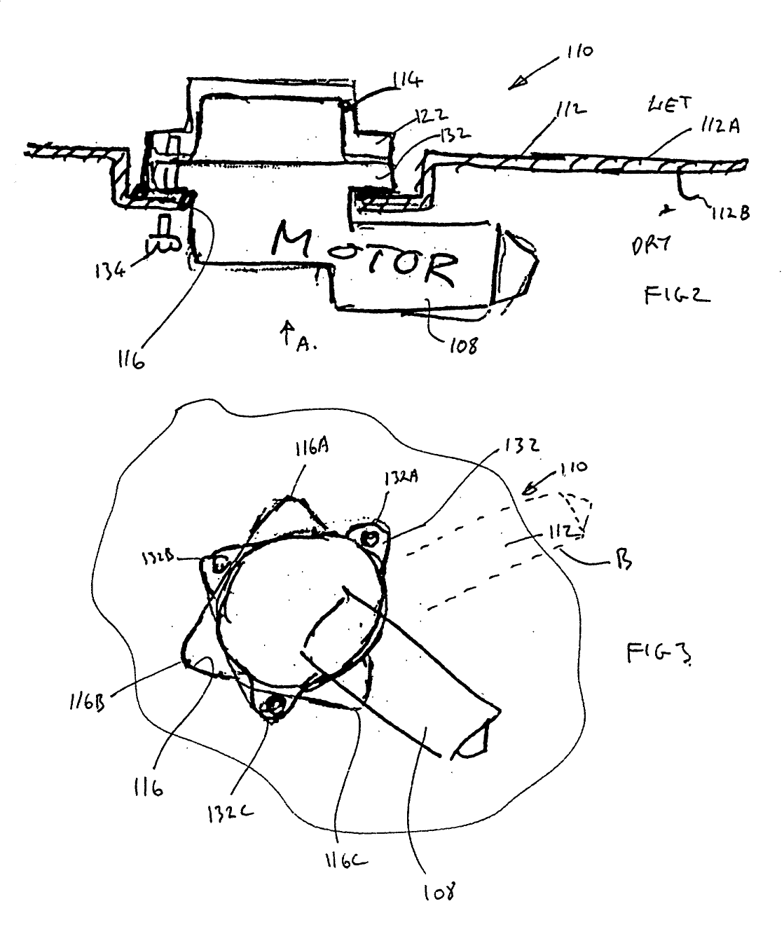

With reference to FIGS. 2 and 3 there is shown a door panel assembly 110 with components which fulfil the same function as door panel assembly 10 labelled 100 greater.

In this case, door panel 112 has a substantially equilateral triangular shaped holes 116 which corresponds to and is slightly larger than the peripheral shape of the cable drum housing 114 and window regulator motor assembly 108 at the interface of these two components, i.e., a cross section taken through lugs 122 or lugs 132 is triangular.

The window regulator motor assembly 108 and cable drum housing 114 are provided as a sub-assembly and then lugs 132A, 132B and 132C (see FIG. 3) are aligned with the corresponding apexes 116A, 116B and 116C of hole 116 to allow cable drum housing 114 and lugs 132 to pass through hole 116 from the dry side to the wet side. Note that the position of motor 108 is shown chain dotted at B during this process.

The window regulator motor assembly and cable drum housing are then rotated through approximately 60 degrees to the position shown in FIG. 3 and bolts 134 (only one shown) can be passed through the clearance holes in panel 112 and lugs 132 and can engage in threaded holes in lugs 122 to secure both the window regulator motor assembly and cable drum housing to the panel 112.

It should be noted that manufacturing tolerance errors on door panel 112 do not affect the alignment between cable drum housing 114 and window regulator motor assembly 108. Furthermore, it can be seen that the motor 108 is located on the dry side of panel 112 and that the window regulator motor assembly 108 and cable drum housing 114 can be assembled from the dry side to the position as shown in FIG. 2 and that bolt 134 can also be secured from the dry side. This is particularly advantageous when window regulator motor assembly 108 has to be replaced in the event of an electrical failure, etc.

In alternative embodiments the window regulator motor assembly may be replaced by a manual window regulator drive mechanism.

The aforementioned description is exemplary rather that limiting. Many modifications and variations of the present invention are possible in light of the above teachings. The preferred embodiments of this invention have been disclosed. However, one of ordinary skill in the art would recognize that certain modifications would come within the scope of this invention. Hence, within the scope of the appended claims, the invention may be practiced otherwise than as specifically described. For this reason the following claims should be studied to determine the true scope and content of this invention.

We claim:

1. A door panel assembly including a door panel having a dry side and a wet side, a drive mechanism being secured to the door panel via at least a first mounting feature and a cable drum being secured to the door panel via at least a second mounting feature, in which the at least one first and the at least one second mounting features are located on the same side of the door panel.

2. A door panel assembly as defined in claim 1 in which the at least one second mounting feature is sandwiched between the at least one first mounting feature and the door panel on the dry side.

3. A door panel assembly as defined in claim 1 in which a portion of the cable drum housing projects through the door panel on the wet side.

4. A door panel assembly as defined in claim 1 in which the at least one first mounting feature is sandwiched between the at least one second mounting feature and the door panel on the wet side.

5. A door panel assembly as defined in claim 1 in which the drive mechanism includes a drive system capable of driving a cable drum mounted on an axle in the cable drum housing with the drive being substantially located on the dry side and with the axle being at least partially located on the wet side.

6. A door panel assembly as defined in claim 1 in which the drive mechanism includes a motor.

7. A door panel assembly as defined in claim 1 in which at least one fastener acts to secure both the drive mechanism and the cable drum housing to the door panel.

8. A door panel assembly as defined in claim 7 in which the at least one fastener passes through the at least one of the first and second mounting features to secure the drive mechanism and cable drum housing to the door panel.

9. A door panel assembly as defined in claim 1 in which alignment features on the drive mechanism engage corresponding features on the cable drum housing to align the drive mechanism relative to the cable drum housing.

10. A door panel assembly as defined in claim 9 in which the alignment features include fingers on the drive mechanism for engagement with the inner periphery of a housing portion of the cable drum housing.

11. A door panel assembly as defined in claim 9 in which the alignment features further secure the drive mechanism relative to the cable drum housing.

12. A door panel assembly as defined in claim 1 in which there are three first mounting features and three second mounting features.

13. A method of assembling a door panel assembly, comprising the steps of:
providing a door panel having a dry side and a wet side;
securing a drive mechanism to the door panel via at least a first mounting feature;
securing a cable drum to the door panel via at least a second mounting feature wherein the at least first and the at least one second mounting features are located on the same side of the door panel; and
providing a sub-assembly of a drive mechanism and a cable drum housing, assembling the sub-assembly on to the door panel and securing it thereto.

14. A method of assembling a door panel according to claim 13 including the step of providing a door panel with a hole, passing the cable drum housing and said at least one second mounting feature through the hole and securing the said assembly to the door panel.

15. A method of assembling a door panel according to claim 14 further including the step of rotating the sub-assembly once it has been passed through the hole to align the at least one first and second mounting features at an attaching position and then securing the sub-assembly to the door panel.
